(19) United States
(12) Patent Application Publication
(10) Pub. No.: US 2020/0122468 A1
(43) Pub. Date: Apr. 23, 2020

(54) INK MIST COLLECTION DEVICE AND INKJET RECORDING APPARATUS

(71) Applicant: Konica Minolta, Inc., Tokyo (JP)

(72) Inventor: Junichiro TAKAHASHI, Tokyo (JP)

(21) Appl. No.: 16/654,780

(22) Filed: Oct. 16, 2019

(30) Foreign Application Priority Data
Oct. 22, 2018 (JP) 2018-198352

(51) Int. Cl. B41J 2/165

(52) U.S. Cl. CPC B41J 2/16523

(57) ABSTRACT

An ink mist collection device includes: a vent including a mist inflow port that allows ink mist to flow thereinto, the ink mist being generated when an ink ejector that ejects an ink toward a recording medium ejects the ink; a suction fan that causes the ink mist to flow into the vent via the mist inflow port and sucks the ink mist that has flowed in; and a collection member provided between the mist inflow port inside the vent and the suction fan, the collection member collecting the ink mist that has flowed into the vent, and the suction fan and the collection member are configured such that a travel speed of the ink mist travelling inside the collection member in an orthogonal direction orthogonal to a suction direction of the ink mist is uniform.

### CROSS REFERENCE TO RELATED APPLICATIONS

The entire disclosure of Japanese Patent Application No. 2018-198352 filed on Oct. 22, 2018 is incorporated herein by reference in its entirety.

### BACKGROUND

### Technological Field

The present invention relates to an ink mist collection device and an inkjet recording apparatus.

### Description of Related Art

Inkjet recording apparatuses have been conventionally known that record an image on a recording medium by ejecting an ink from a nozzle of an ink ejection section.

Such inkjet recording apparatuses have the problem of, at the time of ejecting ink droplets, the ink droplet (main droplets) being generated and flying alone and fine droplets accompanying the ink droplets forming mist and flying as ink mist and adhering to the periphery.

Adherence of such ink mist to a recording medium deteriorates the quality of an image recorded on the recording medium. Also, adherence and solidification of the ink mist on a nozzle orifice portion (ejection port) of an ink ejection section adversely affect a direction of ejection of ink droplets and/or an amount of ejected ink droplets and adherence of the ink mist to a peripheral sensor surface or the like lowers the scan accuracy of a sensor.

In response to the above problem, a technique in which a suction section that sucks ink mist (for example, suction fan) is provided to suck and collect ink mist to suppress a failure attributable to ink mist has been proposed (see, for example, Japanese Patent Application Laid-Open No. 2004-181725). In such technique, ink mist is sucked at a position close to a nozzle to suck ink mist immediately after generation of the ink mist and thereby effectively suppress a failure attributable to the ink mist.

In the above technique in which a suction fan is provided to suck ink mist, a collection member that collects ink mist using, for example, a porous body may be provided on the upstream side, in a direction in which ink mist is sucked, of a suction fan.

In this case, for example, when an amount of ink ejected and thus an amount of ink mist generated during image recording are large, it is necessary to increase an amount of ink mist sucked, and thus, for example, in the technique described in Japanese Patent Application Laid-Open No. 2007-136847, a suction force (air volume) of a suction fan is controlled according to an amount of ink ejected during image recording.

However, when the suction force of the suction fan is, for example, excessively increased according to the amount of ink ejected during image recording, a situation in which collection by the collection member is difficult (that is, a situation in which an excessive suction load is imposed on the collection member) may occur, resulting in slippage of ink mist through the collection member. The slippage of ink mist through the collection member causes discharge of ink mist from an exhaust section of the suction fan and/or a failure and decrease in life of the suction fan due to adherence of ink mist to a driving section of the suction fan.

### SUMMARY

An object of the present invention is to provide an ink mist collection device and an inkjet recording apparatus capable of, even when a suction force of a suction fan is increased, suppressing slippage of ink mist through a collection member.

To achieve at least one of the abovementioned objects, according to an aspect of the present invention, an ink mist collection device reflecting one aspect of the present invention comprises:

a vent including a mist inflow port that allows ink mist to flow thereinto, the ink mist being generated when an ink ejector that ejects an ink toward a recording medium ejects the ink;

a suction fan that causes the ink mist to flow into the vent via the mist inflow port and sucks the ink mist that has flowed in; and

a collection member provided between the mist inflow port inside the vent and the suction fan, the collection member collecting the ink mist that has flowed into the vent,

wherein the suction fan and the collection member are configured such that a travel speed of the ink mist travelling inside the collection member in an orthogonal direction orthogonal to a suction direction of the ink mist is uniform.

To achieve at least one of the abovementioned objects, according to an aspect of the present invention, an inkjet recording apparatus reflecting one aspect of the present invention comprises:

the ink ejector; and

the ink mist collection device described above.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram illustrating a schematic configuration of an inkjet recording apparatus according to an embodiment;

FIG. 2 is a block diagram illustrating a major functional configuration of the inkjet recording apparatus according to the present embodiment;

FIG. 3 is a plan sectional view illustrating an inner configuration of a conventional mist collection section;

FIGS. 4A and 4B are plan sectional views each illustrating an inner configuration of a mist collection section according to the present embodiment;

FIGS. 5A and 5B are diagrams each illustrating an alteration of the inner configuration of the mist collection section according to the present embodiment;

FIGS. 6A, 6B and 6C are diagrams illustrating distributions of suction air speeds inside a collection member; and

FIGS. 7A, 7B and 7C are diagrams illustrating distributions of suction air speeds inside a collection member.

### DETAILED DESCRIPTION OF EMBODIMENTS

Hereinafter, one or more embodiments of the present invention will be described with reference to the drawings. However, the scope of the invention is not limited to the disclosed embodiments.

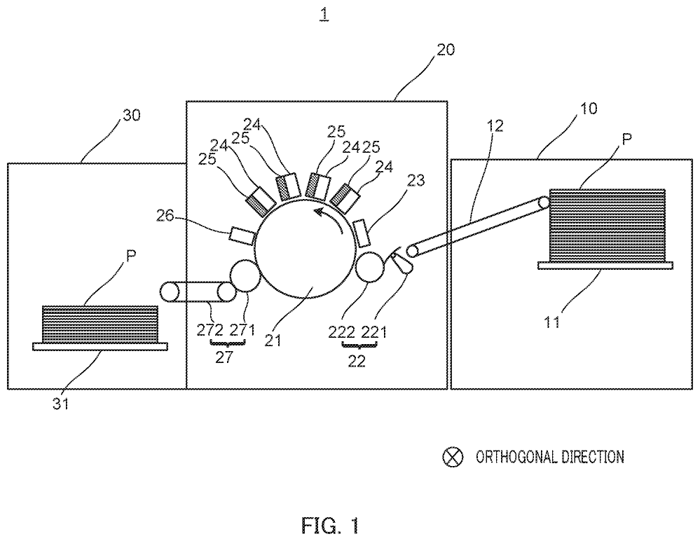

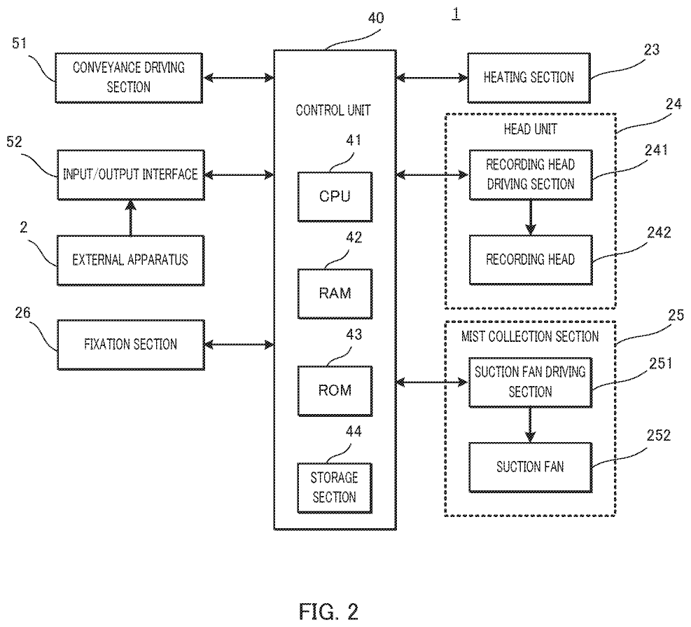

FIG. 1 is a diagram illustrating a schematic configuration of inkjet recording apparatus 1 according to an embodiment. Inkjet recording apparatus 1 includes sheet feed section 10, image recording section 20, sheet ejection section 30 and control unit 40 (see FIG. 2). Under the control of control unit 40, inkjet recording apparatus 1 conveys recording medium P stored in sheet feed section 10 to image recording section 20, records an image on recording medium P via image recording section 20 and conveys recording medium P with the image recorded thereon to sheet ejection section 30. For recording medium P, any of various mediums that enable fixing an ink landed on a surface thereof such as a fabric or a sheet-like resin as well as normal paper or coated paper can be used.

Sheet feed section 10 includes sheet feed tray 11 that stores recording mediums P and medium supply section 12 that conveys and supplies recording mediums P from sheet feed tray 11 to image recording section 20. Medium supply section 12 includes a looped belt, the inside of which is supported by two rollers, and each recording medium P is conveyed from sheet feed tray 11 to image recording section 20 by rotating the rollers with recording medium P mounted on the belt.

Image recording section 20 includes conveyance drum 21, delivery unit 22, heating section 23, head units 24, mist collection sections 25 (corresponding to “ink mist collection device” in the present invention), fixation section 26 and delivery section 27.

Conveyance drum 21 rotates around a rotation axis extending in a direction perpendicular to the sheet of FIG. 1 (hereinafter referred to as “orthogonal direction”) with recording medium P held on an outer circumferential curved surface (conveyance surface) having a cylindrical surface shape conveys recording medium P in a conveyance direction along the conveyance surface. Conveyance drum 21 includes non-illustrated lug portions and a suction section for holding recording medium P, on the conveyance surface. End portions of recording medium P are held by the lug portion, and recording medium P is sucked to the conveyance surface by the suction section and is hereby held on the conveyance surface. Conveyance drum 21 includes a non-illustrated conveyance drum motor for rotating conveyance drum 21 and rotates by an angle proportional to an amount of rotation of the conveyance drum motor.

Delivery unit 22 delivers recording medium P conveyed by medium supply section 12 of sheet feed section 10, to conveyance drum 21. Delivery unit 22 is provided at a position between medium supply section 12 of sheet feed section 10 and conveyance drum 21, and an end of recording medium P conveyed from medium supply section 12 is held and picked up by swing arm section 221 and delivered to conveyance drum 21 via delivery drum 222.

Heating section 23, which is provided between a position at which delivery drum 222 is disposed and a position at which head unit 24 is disposed, heats the conveyance surface of conveyance drum 21 and recording medium P conveyed by conveyance drum 21 so that a temperature of recording medium P falls within a predetermined temperature range. Heating section 23 includes, for example, an infrared heater and supplies power to the infrared heater based on a control signal supplied from control unit 40 (see FIG. 2) to cause the infrared heater to generate heat.

Each head unit 24 records an image by ejecting ink onto recording medium P from a nozzle orifice portion (corresponding to “ejection port” in the present invention) provided in an ink ejection surface facing the conveyance surface of conveyance drum 21, at a proper timing according to rotation of conveyance drum 21 with recording medium P held thereon. Head units 24 are arranged so that the ink ejection surface and the conveyance surface are spaced with a predetermined distance from each other.

In inkjet recording apparatus 1 according to the present embodiment, four head units 24 corresponding to inks of four colors, yellow (Y), magenta (M), cyan (C) and black (K), respectively, are aligned at predetermined intervals in the order of Y, M, C and K from the upstream side in the conveyance direction of recording medium P.

Each head unit 24 includes recording head 242 (see FIG. 2; recording head 242 corresponds to “ink ejection section” in the present invention). In recording head 242, a plurality of recording elements each including a pressure chamber that stores the relevant ink, a piezoelectric element provided on a wall surface of the pressure chamber and a nozzle are provided. In each recording element, upon a driving signal that causes the relevant piezoelectric element to operate to deform being input, the relevant pressure chamber deforms due to the deformation of the piezoelectric element and pressure inside the pressure chamber thus changes, causing the ink to be ejected from the relevant nozzle communicating with the pressure chamber.

A range in which the nozzles included in each recording head 242 are arranged in the orthogonal direction covers a width in the orthogonal direction of an area, with an image to be recorded thereon, of recording medium P to be conveyed by conveyance drum 21. During image recording, each head unit 24 is used in such a manner that a position of head unit 24 is fixed relative to the rotation axis of conveyance drum 21. In other words, inkjet recording apparatus 1 is a single-pass inkjet recording apparatus.

For the ink to be ejected from each recording head 242, one having a property of changing in phase to a gel or a sol depending on the temperature and being cured by irradiation with an energy ray such as an ultraviolet ray is used. Also, in the present embodiment, an ink that is a gel in room temperature and turns into a sol upon being heated is used. Each head unit 24 includes an ink heating section (not illustrated) that heats the ink stored in head unit 24. The ink heating section operates under the control of control unit 40 and heats the ink to a temperature that causes the ink to turn into a sol. Head unit 24 ejects the ink that has turned into a sol by being heated. Upon the sol ink being ejected onto recording medium P, ink droplets are landed on recording medium P and then naturally cooled, whereby the ink quickly turns into a gel and is solidified on recording medium P.

Mist collection sections 25 each suck and collect fine mist ink (ink mist) generated accompanying ejection of ink from the nozzle of relevant recording head 242. Each of mist collection sections 25 is provided on the downstream side in the conveyance direction of the relevant one of four head units 24 and four mist collection sections 25 have a same structure.

Each mist collection section 25 discharges internal air by means of rotation of suction fan 252 (see FIG. 2) and thereby sucks ink mist from a suction surface facing the conveyance surface of the conveyance drum 21. A specific configuration of mist collection section 25 will be described later.

Fixation section 26 includes a light emission section disposed over a width in the orthogonal direction of conveyance drum 21. Fixation section 26 applies an energy ray such as an ultraviolet ray from the light emission section to recording medium P mounted on conveyance drum 21 to provide predetermined energy to ink ejected on recording medium P and thereby causes the ink to be cured and fixed. The light emission section of fixation section 26 is disposed between a position at which mist collection section 25 is disposed and a position at which delivery drum 271 (delivery section 27) is disposed in the conveyance direction so as to face the conveyance surface of conveyance drum 21.

Delivery section 27 includes belt loop 272 including a looped belt, the inside of which is supported by two rollers, and cylindrical delivery drum 271 that delivers recording medium P from conveyance drum 21 to belt loop 272, and recording medium P delivered from conveyance drum 21 onto belt loop 272 by delivery drum 271 is conveyed by belt loop 272 and fed out to sheet ejection section 30.

Sheet ejection section 30 includes plate-like sheet tray 31 that allows recording medium P fed out from image recording section 20 by delivery section 27 to be placed thereon.

FIG. 2 is a block diagram illustrating a major functional configuration of inkjet recording apparatus 1. Inkjet recording apparatus 1 includes heating section 23, recording head driving sections 241 and recording heads 242 included in respective head units 24, suction fan driving sections 251 and suction fans 252 included in respective mist collection sections 25, fixation section 26, control unit 40, conveyance driving section 51 and input/output interface 52.

Each recording head driving section 241 supplies a driving signal for causing the piezoelectric element of relevant recording head 242 to deform according to image data to the relevant recording elements at a proper timing under the control of control unit 40 and thereby causes an amount of ink corresponding to a pixel value of the image data to be ejected from the nozzle of recording head 242.

Each suction fan driving section 251 causes suction fan 252 of relevant mist collection section 25 to operate under the control of control unit 40.

Control unit 40 includes CPU 41 (central processing unit), RAM 42 (random access memory), ROM 43 (read-only memory) and storage section 44.

CPU 41 reads out various control programs and setting data stored in ROM 43, causes the programs and the setting data to be stored in RAM 42 and executes the programs to perform various types of arithmetic processing. Also, CPU 41 performs integrated control of overall operation of inkjet recording apparatus 1.

RAM 42 provides a working memory space to CPU 41 and temporarily stores data. Note that RAM 42 may include a non-volatile memory.

ROM 43 stores, for example, various control programs to be executed by CPU 41 and the setting data. Note that instead of ROM 43, a rewritable non-volatile memory such as EEPROM (electrically erasable programmable read-only memory) or a flash memory may be used.

In storage section 44, a print job (image recording instruction) input from external apparatus 2 via input/output interface 52 and image data relating to the print job are stored. For storage section 44, for example, an HDD (hard disk drive) is used and, for example, a DRAM (dynamic random-access memory) may be used together with the HDD.

Conveyance driving section 51 supplies a driving signal to the conveyance drum motor of conveyance drum 21 based on a control signal supplied from control unit 40 to rotate conveyance drum 21 at a predetermined speed and timing. Also, conveyance driving section 51 supplies a driving signal to respective motors for causing medium supply section 12, delivery unit 22 and delivery section 27 to operate, based on a control signal supplied from control unit 40 to perform supply of recording medium P to conveyance drum 21 and ejection of recording medium P from conveyance drum 21.

Input/output interface 52 mediates data transmission/reception between external apparatus 2 and control unit 40. Input/output interface 52 is formed of, for example, any of various serial interfaces, various parallel interfaces or any combination thereof.

External apparatus 2 is, for example, a personal computer, and supplies, for example, an image recording instruction (print job) and image data to control unit 40 via input/output interface 52.

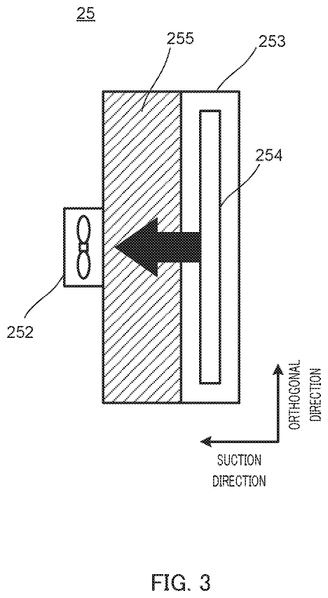

FIG. 3 is a plan sectional view illustrating an inner configuration of conventional mist collection section 25. Mist collection section 25 is longer than head unit 24 (conveyance drum 21) in the orthogonal direction. Mist collection section 25 includes suction fan 252, duct 253 (corresponding to “vent” in the present invention), suction port 254 and collection member 255.

Suction port 254 is formed in a bottom surface (suction surface) of duct 253 so as to have a rectangular shape extending in the orthogonal direction, and lets ink mist generated accompanying ejection of ink from the nozzle of recording head 242 flow into duct 253.

Collection member 255 is provided between suction port 254 and suction fan 252 in a suction direction of suction by suction fan 252 (corresponding to the conveyance direction of conveyance of recording medium P) and collects the ink mist that has flowed into duct 253 via suction port 254.

Collection member 255 includes microscopic pores that have gas (air) pass through in the suction direction. The microscopic pores can be provided by use of a porous material (for example, an open-cell sponge including open cells inside) or a material having a fine mesh structure as collection member 255. Note that for collection member 255, one from a broad range of materials that can absorb ink mist can be employed. Examples of such material for collection member 255 include paper, unwoven fabric and synthetic resin.

Suction fan 252 is provided at a position facing a center portion in the orthogonal direction of collection member 255. Suction fan 252 is a normal rotary fan, and upon being rotated, performs a suction operation of sucking ink mist from suction port 254 together with air. The sucked ink mist is collected by collection member 255 and only the air sucked together with the ink mist is discharged to the outside of mist collection section 25.

Suction fan 252 rotates upon being supplied with a predetermined voltage from a non-illustrated power supply section. A speed of rotation of suction fan 252 may be set monotonously or may be set to be variable in a plurality of levels. When the speed of rotation of suction fan 252 is variable, the rotation speed is changed, for example, by changing a pulse width of power supplied from the power supply section by means of PWM (pulse width modulation) performed by, for example, control processing by control unit 40.

For example, when an ink ejection amount and thus an ink mist generation amount are large during image recording, control unit 40 needs to increase an amount of ink mist to be sucked and thus performs control to increase a suction force (air volume) of suction fan 252. However, for example, an excessive increase of a suction force of a suction fan according to an amount of ink ejected during image recording may cause a situation in which collection by collection member 255 is difficult (situation in which what is called an excessive suction load is imposed on collection member 255), resulting in slippage of ink mist through collection member 255.

More specifically, in the configuration of conventional mist collection section 25 illustrated in FIG. 3, one suction fan 252 is provided at a position facing the center portion in the orthogonal direction of collection member 255. Therefore, as indicated by the bold arrow in FIG. 3, in the orthogonal direction, a travel speed of ink mist traveling inside collection member 255 is particularly large at a position facing the center portion in the orthogonal direction of collection member 255 and ink mist slips through the collection member 255 at that position. The slippage of ink mist through collection member 255 causes discharge of ink mist from an exhaust section (not illustrated) of suction fan 252 and/or causes a failure and a decrease in life of suction fan 252 due to adherence of ink mist to the driving section (not illustrated) of suction fan 252.

Therefore, in the present embodiment, in order to suppress slippage of ink mist through collection member 255 even when a suction force of suction fan 252 is increased, suction fan 252 and collection member 255 are configured such that a travel speed of ink mist travelling inside collection member 255 is uniform in the orthogonal direction orthogonal to the suction direction of ink mist.

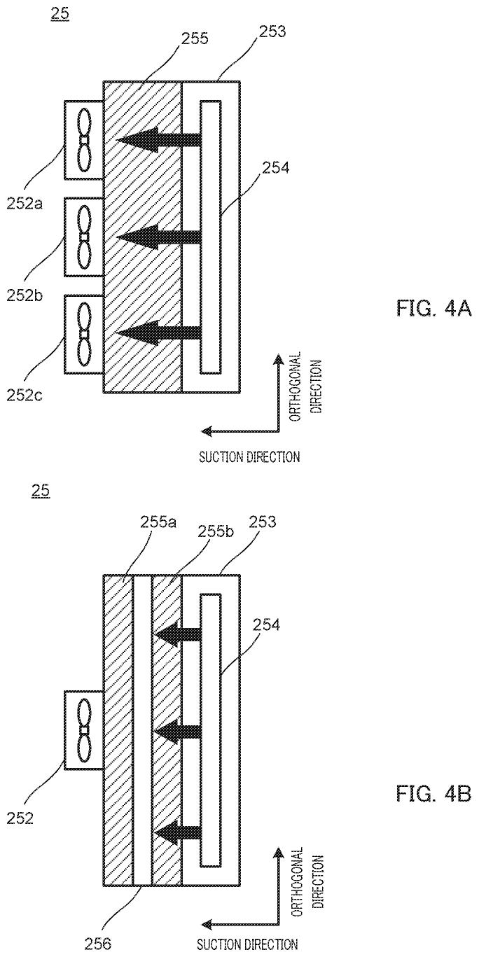

FIG. 4 is a plan sectional view of an inner configuration of mist collection section 25 in the present embodiment. In mist collection section 25 illustrated in FIG. 4A, a plurality of suction fans 252a, 252b, 252c are arranged in the orthogonal direction. Control unit 40 performs control to drive the plurality of suction fans 252a, 252b, 252c simultaneously to suck ink mist.

Control unit 40 changes the number of suction fans to be driven simultaneously from among suction fans 252a, 252b, 252c according to the amount of ink mist generated when recording head 242 ejects ink. More specifically, control unit 40 increases the number of suction fans to be driven simultaneously from among suction fans 252a, 252b, 252c in response to an increase in amount of ink mist.

Control unit 40 calculates an amount of ink mist based on an image recording condition in recording an image on recording medium P. The image recording condition may be, for example, an amount of ink ejected from recording head 242, the area of an image to be recorded on recording medium P, a recording speed of recording the image on recording medium P, a distance between a nozzle orifice portion of the recording head 242 from which ink is ejected and recording medium P or the type of recording medium P.

For example, as the amount of ink ejected from recording head 242 is larger, the amount of ink mist is larger and thus control unit 40 calculates the amount of ink mist based on the amount of ink ejected.

Also, as the area of an image to be recorded on recording medium P is larger, the amount of ink mist is larger and thus control unit 40 calculates the amount of ink mist based on the area of the image.

Also, as a recording speed of recording an image on recording medium P is larger, that is, an amount of ink ejected per unit of time is larger, the amount of ink mist is larger, and thus, control unit 40 calculates the amount of ink mist based on the recording speed.

Also, as a distance between a nozzle orifice portion of recording head 242 from which ink is ejected and recording medium P is larger, the amount of ink mist flying without being landed on recording medium P is larger, and thus, control unit 40 calculates the amount of ink mist based on the distance.

Also, the distance between the orifice portion of the nozzle of recording head 242 from which ink is ejected and recording medium P varies depending on a property specified by the type of recording medium P, for example, a thickness of recording medium P, enabling determination of whether the amount of ink mist is large or small, and thus, control unit 40 calculates the amount of ink mist based on the type of recording medium P.

In the present embodiment, even when control unit 40 increases a total suction force of suction fans by driving the plurality of suction fans 252a, 252b, 252c simultaneously to suck ink mist, as indicated by the three bold arrows in FIG. 4A, dispersion of the suction force by suction fans 252a, 252b, 252c make a travel speed of ink mist travelling inside collection member 255 uniform in the orthogonal direction. Therefore, a travel speed of ink mist travelling inside collection member 255 when a suction force of suction fans 252a, 252b, 252c is increased to increase an amount of ink mist sucked can be made to be substantially equal to that when an amount of ink mist sucked is not increased (that is, when the plurality of suction fans 252a, 252b, 252c are not driven simultaneously). Therefore, when the total suction force of suction fans is increased by driving the plurality of suction fans 252a, 252b, 252c simultaneously, generation of an excessive suction load is avoided at any position in the orthogonal direction in collection member 255 and ink mist is collected by collection member 255, enabling preventing the ink mist from slipping through collection member 255.

Note that when the amount of ink mist generated when recording head 242 ejects ink is small, control unit 40 does not necessarily need to drive the plurality of suction fans 252a, 252b, 252c simultaneously. When the amount of ink mist generated is small, ink droplets ejected are minuscule or an image recorded on recording medium P is an image formed of isolated dots, and thus, under an atmosphere in which ink is ejected from recording head 242, the ink is susceptible to a flow of air caused by a suction operation, which may adversely affect a direction of ejection and an amount of ink droplets ejected, resulting in generation of a defective image due to, for example, landing of the ink droplets on respective incorrect positions.

In mist collection section 25 illustrated in FIG. 4B, one suction fan 252 is provided at a position facing a center part in the orthogonal direction of collection member 255. Also, two collection members 255a, 255b are disposed with an interval (space 256) therebetween in the suction direction.

Control unit 40 changes a rotation frequency, thus, a suction force of suction fan 252 according to the amount of ink mist generated when recording head 242 ejects ink. More specifically, control unit 40 increases the suction force of suction fan 252 according to an increase in amount of ink mist.

As described above, control unit 40 calculates an amount of ink mist based on an image recording condition in recording an image on recording medium P. The image recording condition may be, for example, an amount of ink ejected by recording head 242, the area of the image to be recorded on recording medium P, a recording speed of recording an image on recording medium P, a distance between a nozzle orifice portion of recording head 242 from which ink is ejected and recording medium P or the type of recording medium P.

In the present embodiment, as indicated by the bold arrow in FIG. 4B, two collection members 255a, 255b are arranged in the suction direction with a space therebetween, which makes a travel speed of ink mist travelling inside collection member 255b is uniform in the orthogonal direction. A specific reason of the uniformity will be described below. First, provision of collection member 255a close to suction fan 252 causes a pressure loss in suction air linearly flowing toward suction fan 252 (having directivity). As a result, the suction air is dispersed in the orthogonal direction and loses the directivity. Furthermore, the action of making pressure (negative pressure) be uniform in the orthogonal direction occurs in space 256 provided between collection member 255a and collection member 255b, which makes the suction force that has lost the directivity be uniform in the orthogonal direction, thus, the travel speed of ink mist travelling inside collection member 255b be uniform in the orthogonal direction.

Therefore, in a case where the suction force of suction fan 252 is increased to increase an amount of ink mist sucked, also, a travel speed of ink mist travelling inside collection member 255b can be made to be substantially equal to that in a case where an amount of ink mist sucked is not increased in a configuration in which single collection member 255 is provided (see FIG. 3). Therefore, even when the suction force of suction fan 252 is increased, a situation in which an excessive suction load is imposed on collection member 255b can be avoided and ink mist can be collected by collection member 255b, preventing the ink mist from slipping through collection member 255b.

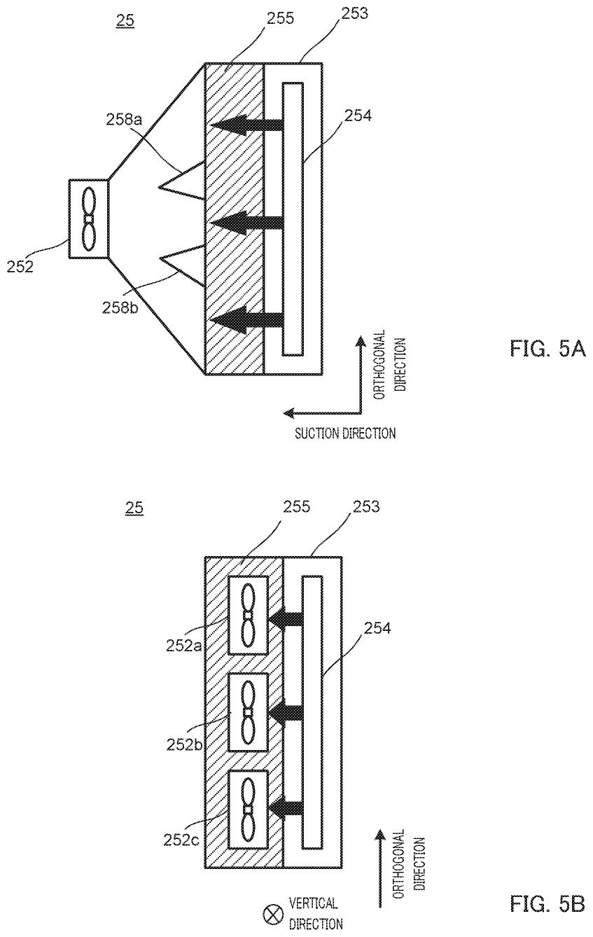

Note that in the above-described embodiment, as illustrated in FIG. 5A, rectification members 258a, 258b may be disposed on the downstream side of collection member 255 in the suction direction so that a travel speed of ink mist travelling inside collection member 255 is uniform in the orthogonal direction. As a result of the disposition of rectification members 258a, 258b, conductances of respective flow paths in the orthogonal direction inside duct 253 are adjusted, enabling a suction air speed to be uniform, thus, making the travel speed of ink mist travelling inside collection member 255 (see the bold arrows) uniform in the orthogonal direction. However, from the perspective of minimizing a size of mist collection section 25, it is preferable that the configuration of mist collection section 25 is of the configurations in FIGS. 4A and 4B.

Also, although the above-described embodiment has been described in terms of an example in which suction fan(s) 252a, 252b, 252c (252) are disposed on the downstream side, in the conveyance direction of conveyance of recording medium P, of collection member(s) 255 (255a, 255b), the present invention is not limited to this example. For example, as illustrated in FIG. 5B, suction fans 252a, 252b, 252c may be disposed on the downstream side, in a vertical direction of mist collection section 25 (in the direction perpendicular to the sheet of FIG. 5B), of collection member 255.

Also, in the above-described embodiment, since a suction force of a suction fan is increased, slippage of ink mist through a collection member can be suppressed, mist collection section 25 which would have been provided in each of the respective colors of Y, M, C and K, may be provided only at a most downstream position in the conveyance direction of recording medium P to collectively suck ink mist. This configuration enables downsizing of mist collection section 25.

Also, although the above-described embodiment has been described using an example in which recording medium P is conveyed by conveyance drum 21, instead, recording medium P may be conveyed by a conveyance belt that is supported by two rollers and moves in response to rotation of the rollers.

Also, the above embodiment is a mere example of embodiment in carrying out the present invention, and the technical scope of the present invention should not be limited to the embodiment. In other words, the present invention can be carried out in various modes without departing from the spirit or a main feature of the invention.

### Example Tests

Lastly, evaluation tests 1 and 2 for confirming effects of the configuration of the above-described embodiment will be described.

(Configuration of Mist Collection Section 25 in Evaluation Test 1)

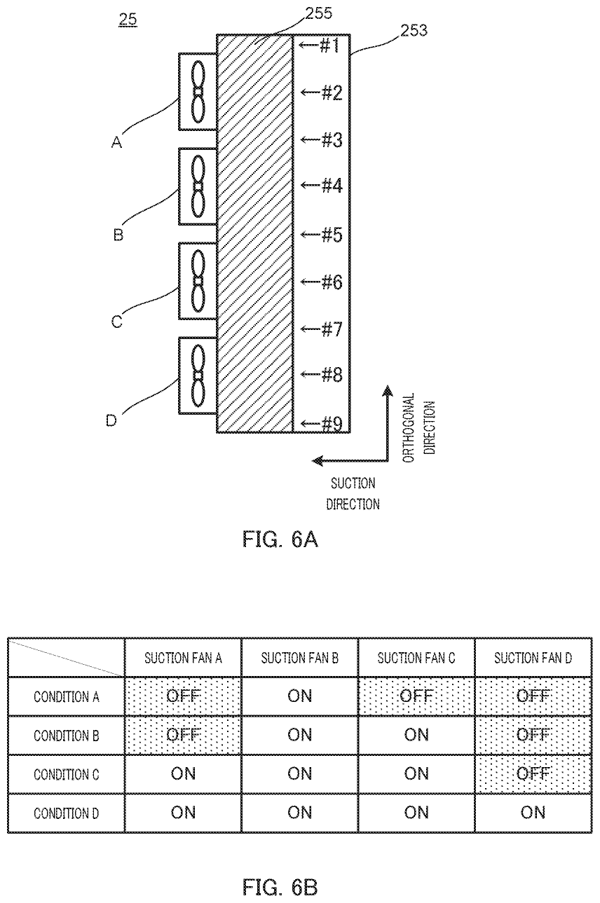

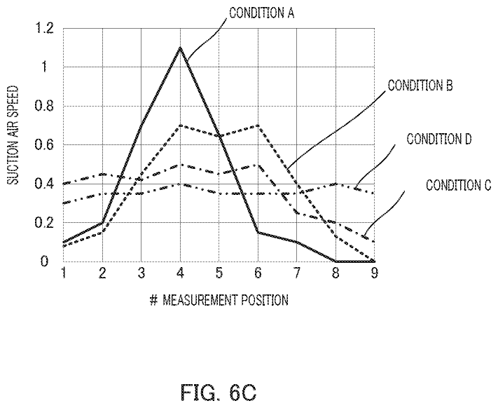

As illustrated in FIG. 6A, in mist collection section 25 in evaluation test 1, a plurality of suction fans A, B, C, D are arranged in an orthogonal direction orthogonal to a suction direction of suction of ink mist. One collection member 255 is disposed on the upstream side in the suction direction of suction fans A, B, C, D.

(Method of Evaluation Test 1)

In evaluation test 1, a condition in driving suction fans A, B, C, D was switched from one to another and a distribution of travel speeds (suction air speeds) in the orthogonal direction (measurement positions #1 to #9) of ink mist travelling inside collection member 255 was confirmed under each of the conditions.

As illustrated in FIG. 6B, for the condition in driving suction fans A, B, C, D, conditions A to D were provided. Under condition A, only suction fan B was driven and suction fans A, C, D were not driven. Under condition B, suction fans B, C were driven simultaneously and suction fans A, D were not driven. Under condition C, suction fans A to C were driven simultaneously and only suction fan D was not driven. Under condition D, all of suction fans A to D were drive simultaneously. Note that in conditions A to D, respective conditions for a total suction force of suction fans were made to be equal to one another.

FIG. 6C is a diagram indicating a relationship between measurement positions #1 to #9 in the orthogonal direction inside collection member 255 and ink mist travel speeds (suction air speeds). As illustrated in FIG. 6C, it can be seen that in comparison with the case where only suction fan B was driven to suck ink mist (condition A), in each of the cases where a plurality of suction fans from among suction fans A, B, C, D were driven simultaneously to suck ink mist (conditions B to D), suction air speeds became close to uniform in the orthogonal direction and a maximum value of the suction air speeds was small. Therefore, even when a plurality of suction fans from among suction fans A, B, C, D are driven simultaneously to increase a total suction force of the suction fans, imposition of an excessive suction load on collection member 255 can be avoided and ink mist can be collected by collection member 255, preventing the ink mist from slipping through collection member 255.

Furthermore, in the configuration of evaluation test 1, when an image was recorded on recording medium P and a plurality of suction fans from among suction fans A, B, C, D were driven simultaneously to suck ink mist, it was visually confirmed that no ink mist slipped through collection member 255 even though the number of recording mediums with an image recorded thereon amounted to 6000.

(Configuration of Mist Collection Section 25 in Evaluation Test 2)

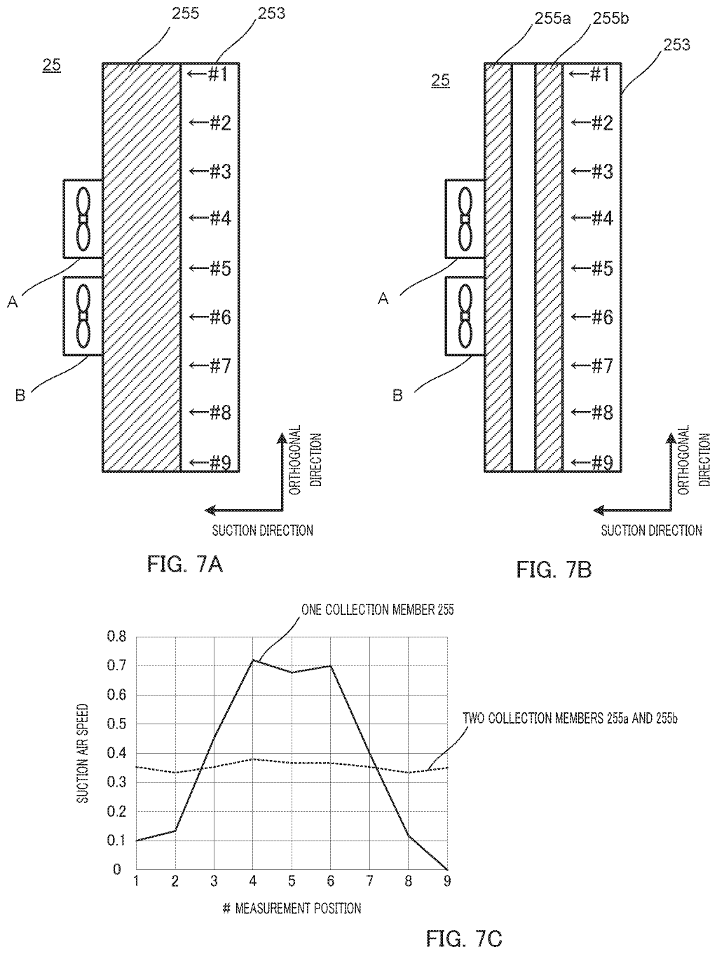

In mist collection section 25 in evaluation test 2, as illustrated in FIGS. 7A and 7B, a plurality of suction fans A, B were arranged in an orthogonal direction orthogonal to a suction direction of suction of ink mist. In mist collection section 25 illustrated in FIG. 7A, one collection member 255 was disposed on the upstream side in the suction direction of suction fans A, B. In mist collection section 25 illustrated in FIG. 7B, two collection members 255a, 255b were disposed on the upstream side in the suction direction of suction fans A, B.

(Method of Evaluation Test 2)

In evaluation test 2, when a plurality of suction fans A, B were driven simultaneously to suck ink mist, a distribution of travel speeds in the orthogonal direction (measurement positions #1 to #9) of ink mist travelling inside collection member 255 (255b) was confirmed for each of a case where one collection member 255 was disposed and a case where two collection members 255a, 255b were disposed (suction air speeds). Note that a condition for a total suction force of suction fan was equal between the case where one collection member 255 was disposed and the case where two collection members 255a, 255b were disposed.

FIG. 7C is a diagram indicating a relationship between measurement positions #1 to #9 in the orthogonal direction inside collection member 255 and ink mist travel speeds (suction air speeds) for each of the case where one collection member 255 was disposed and the case where two collection members 255a, 255b were disposed. As illustrated in FIG. 7C, in comparison with the case where one collection member 255 was disposed, it can be seen that in the case where two collection members 255a, 255b were disposed, the suction air speed became further closer to uniform in the orthogonal direction and a maximum value of suction air speeds was further smaller. Therefore, provision of space between collection member 255a and collection member 255b enables avoiding a situation in which an excessive suction load is imposed on collection member 255b and thus enables collecting ink mist via collection member 255b and preventing the ink mist from slipping through collection member 255b.

Furthermore, in the configuration of evaluation test 2 (see FIG. 7B), when an image was recorded on recording medium P and a plurality of suction fans A, B were driven simultaneously to suck ink mist, it was visually confirmed that no ink mist slipped through collection members 255a, 255b even when the number of recording mediums with an image recorded thereon amounted to 6000.

According to the results of evaluation tests 1 and 2 above, the effects of the configurations of the above-described embodiment (configurations illustrated in FIGS. 4A and 4B) were confirmed.

Although embodiments of the present invention have been described and illustrated in detail, the disclosed embodiments are made for purpose of illustration and example only and not limitation. The scope of the present invention should be interpreted by terms of the appended claims

What is claimed is:

1. An ink mist collection device, comprising:
a vent including a mist inflow port that allows ink mist to flow thereinto, the ink mist being generated when an ink ejector that ejects an ink toward a recording medium ejects the ink;
a suction fan that causes the ink mist to flow into the vent via the mist inflow port and sucks the ink mist that has flowed in; and
a collection member provided between the mist inflow port inside the vent and the suction fan, the collection member collecting the ink mist that has flowed into the vent,
wherein the suction fan and the collection member are configured such that a travel speed of the ink mist travelling inside the collection member in an orthogonal direction orthogonal to a suction direction of the ink mist is uniform.

2. The ink mist collection device according to claim 1, wherein:
a plurality of the suction fans are arranged in the orthogonal direction; and
the ink mist collection device further comprises a hardware processor that performs control to drive the plurality of the suction fans simultaneously to suck the ink mist.

3. The ink mist collection device according to claim 1, wherein two collection members are disposed with a space therebetween in the suction direction.

4. The ink mist collection device according to claim 2, wherein the hardware processor changes a number of the suction fans to be driven simultaneously, according to an amount of ink mist generated when the ink ejector ejects ink.

5. The ink mist collection device according to claim 3, further comprising a hardware processor that changes a suction force of the suction fan according to an amount of ink mist generated when the ink ejector ejects ink.

6. The ink mist collection device according to claim 4, wherein the hardware processor calculates an amount of the ink mist based on an image recording condition in recording an image on the recording medium.

7. The ink mist collection device according to claim 6, wherein the image recording condition includes an amount of an ink ejected by the ink ejector.

8. The ink mist collection device according to claim 6, wherein the image recording condition includes an area of an image to be recorded on the recording medium.

9. The ink mist collection device according to claim 6, wherein the image recording condition includes a recording speed of recording an image on the recording medium.

10. The ink mist collection device according to claim 6, wherein the image recording condition includes a distance between an ejection port of the ink ejector and the recording medium, the ejection port ejecting an ink.

11. The ink mist collection device according to claim 6, wherein the image recording condition includes a type of the recording medium.

12. An inkjet recording apparatus, comprising:
the ink ejector; and
the ink mist collection device according to claim 1.
